(19) United States
(12) Patent Application Publication
(10) Pub. No.: US 2011/0308641 A1
(43) Pub. Date: Dec. 22, 2011

(54) INTELLIGENT WATER SUPPLY CPU AND WATER TAP

(75) Inventors: Lihong Hu, Fujian (CN); Dengliang Tong, Fujian (CN)

(73) Assignee: XIAMEN CLEASE INDUSTRIES CO., LTD

(21) Appl. No.: 12/673,193

(22) PCT Filed: May 5, 2009
(86) PCT No.: PCT/CN2009/071642

§ 371 Date: Feb. 12, 2010

(30) Foreign Application Priority Data
May 6, 2008 (CN) 200820102257.8

(51) Int. Cl. F16K 17/38

(52) U.S. Cl. 137/468

(57) ABSTRACT

An electronic intelligent touch control water faucet and an intelligent water supply central processor which includes a main body, an upper cover, an electromagnetic valve group, a temperature control and flow control member, a PCB control panel and an operation panel. The main body includes receiving troughs, two water inlet tubes and a water outlet tube communicated through pipes. The temperature control member includes a temperature control valve, a synchronous motor, and a temperature sensor. The temperature control valve communicates with the water inlet tubes and is driven and adjusted by the synchronous motor. PCB control panel controls the synchronous motor. The temperature sensor communicates the outlet water temperature to the PCB control panel. The flow control member includes a flow valve and a motor. The PCB control panel controls the motor driving the flow valve. The flow valve water outlet is connected to the water outlet tube.

### FIELD OF INVENTION

The invention refers to a yielding water control device and water tap utilized in cold and hot water supply system, more particularly, a intelligent water supply CPU and water tap automatic controlling the temperature of yielding water [symbol] discharge.

### BACKGROUND OF TECHNOLOGY

With the improved living standard and developed technology, when consumer choose household electric appliance, except capability and security, consumer regard appearance [symbol] concision and space saving more and more. The present household water heater is directly set up in bathroom, or hided installing a spout and control valve in bathroom merely, user regulate the discharge and temperature of yielding water by control valve. The water of storage bin should be heated to predestinate temperature before using well-known storage water heater with open outlet, and user control the temperature of yielding water in demand by using handle to regulate discharge [symbol] cold-hot mixing rate, but storage bin is cooling along with time delayed. To keep temperature of yielding water satisfactory, the cold-hot mixing rate should be regulated continuously, it is inconvenient.

To keep the temperature of yielding water satisfactory, someone invented intelligent water heater controlling temperature automatically, e.g. Chinese Patent 98219348.3 makes know a intelligent storage water heater with open outlet, it supplies water automatically controlled by no track loop-locked control circuit, sets up 36° C. 38° C. 40° C. 42° C. four kinds alternate temperature of outlet water, regulates cold-hot mixing rate automatic according to selected temperature. But range of alternate temperate is finite, temperature controlled is inexact, flow controlled is impossible, so we regulate manually yet. Intelligent really come true is impossible. Accordingly, a water heater intelligently controlling flow and temperature of outlet water is also installed hided and used conveniently, is in demand.

### SUMMARY OF THE INVENTION

The primary object of the present invent is to provide a intelligent water supply CPU and water tap automatic controlling the temperature of yielding water [symbol] discharge, in order to regulate temperature of yielding water [symbol] discharge exactly, and implement water supply with constant temperature.

The one of other objects of the present invent is to provide an intelligent water supply CPU controlling temperature and flow of outlet water by remote-control in favor to hidden installation.

The subordinate object of the present invent is to provide a intelligent water supply CPU with pressurize function and automatically shut down water supply function, it is convenient and safe operation

The one of other object of the present invent is to provide an electric intelligent touch control water tap.

To realize object mentioned above, problem-solving proposal of the present invent is:

An intelligent water supply CPU, comprising a body, a top head, a magnet valves, a temperature-sensing component, a flow control component, a PCB control panel and an operation panel.

The body mentioned comprises several storage tanks and two inlet pipes [symbol] one outlet pipes, a temperature-sensing component, an electric explosion-protection and a PCB control panel set in body;

The electric magnetic valves mentioned comprise two electric magnet-valves set separately in two inlet pipes;

The temperature-sensing component comprises a temperature-sensing valve [symbol] a synchronous electric machine and a heat detector, two inlet pipes connects temperature-sensing valve through pipeline, synchronous electric machine regulates and drives the temperature-sensing valve, PCB control panel controls the rotation of synchronous electric machine, heat detector situated close to outlet pipe surveys and evaluates the temperature of outlet water and responds to PCB control panel;

The flow control component mentioned comprises a flow valve [symbol] electric machine, outlet of flow valve connects outlet pipe, electric machine regulates and drives flow valve, PCB control panel controls the rotation of electric machine.

The operation panel mentioned connects PCB control panel by data wire or transmits data to PCB control panel by wireless remote-control, bottoms used to adjust the temperature and flow are set on control panel.

Booster pumps comprising booster pump and booster pump electric machine, is et on pipeline between the inlet of flow valve and the outlet of temperature-sensing valve, PCB control panel controls the booster pump electric machine.

A pressure detector is set on pipeline between booster pump and outlet of temperature-sensing valve, surveys and evaluates water pressure, then responds to PCB control panel.

A electric explosion-protection component comprising Hall IC [symbol] permanent magnet [symbol] spring [symbol] restoring pink, spring is fixed in pipeline; restoring pink connects spring, permanent magnet links restoring pink, Hall IC stretching into pipeline closes to permanent magnet, and is connected with PCB control panel through transmission line.

The body mentioned comprises several outlet pipes.

One of other problem-solving proposal of the present invention is: a electric intelligent touch-control water tap, comprises a outlet pipe of water tap [symbol] a control panel [symbol] valve controller box; valve controller box comprises: a body [symbol] a top head [symbol] electric magnet valves [symbol] PCB control panel;

The body mentioned comprises several storage tanks and two inlet poles [symbol] one outlet pipe, temperature-sensing component, electric explosion-protection and PCB control panel set in body;

The electric magnetic valves mentioned comprise two electric magnetic valves set separately in two inlet poles;

The temperature-sensing component mentioned comprises a temperature-sensing valve [symbol] synchronous electric machine and heat detector, two water supply pole connects temperature-sensing valve through ducting, synchronous electric machine regulates and drives the temperature-sensing valve, PCB control panel controls the rotation of synchronous electric machine, heat detector situated close to outlet pipe surveys and evaluates the temperature of outlet water and responses to PCB control panel;

The flow control component mentioned comprises a flow valve [symbol] electric machine, outlet of flow valve connects outlet pipe, electric machine regulates and drives flow valve, PCB control panel controls the rotation of electric machine.

The operation panel mentioned connects PCB control panel by data wire, bottoms used to adjust the temperature and discharge and pilot lamp used to show temperature are set on control panel.

Boost pumps comprising boost pump and boost pump electric machine, is set on pipeline between the inlet of discharge valve and the outlet of temperature-sensing valve, PCB control panel controls the boost pump electric machine.

A pressure detector is set on pipeline between boost pump and outlet of temperature-sensing valve, surveys and evaluates water pressure, then responds to PCB control panel.

A electric explosion-protection component is set between outlet pipe and inlet pipe of flow valve, comprising Hall IC [symbol] permanent magnet [symbol] spring [symbol] restoring pink, spring is fixed in pipeline; restoring pink connects spring, permanent magnet links restoring pink, Hall IC stretching into pipeline close to permanent magnet, and is connected with PBC control panel through transmission line.

Utilizing proposal mentioned above, the present invention, two inlet pipes connect cold-hot pipe of water heater separately, user sets up water temperature in demand by control panel, PCB control panel receives information sent by control panel, and sends instruction to control the positive rotation or reversed rotation of synchronous electric machine after comparing this temperature with outlet water temperature by heat detector, then regulates and drives temperature-sensing valve to regulate mixture ratio of cold-hot water, thus we can regulates water temperature exactly and supplies thermostatic water. User controls flow also by control panel, PCB control panel receives information sent by control panel, and sends instruction that control electric machine to drive flow valve to regulate flow, thus user control flow.

In addition to this, the present invention added boost pump has pressurizing function. When water pressure cut down, control electrical machine drives the flow valve to regulate the discharge, thus controls the flow.

In addition to this, the present invention added boost pump has pressurizing function. When water pressure cut down, pressurize achieves either by control panel or by detector component which can detect pressure. Improving security with electric explosion-protection component, when automatically forcedly shut down or standby because waterway is blocked or water supply is cut off.

To save space resources and have aesthetic effect, hot water heater can be installed hidden and nozzle appears outside only. Control panel transmits data to PCB control panel by controller using wireless remote, operation is easy. Moreover, with several outlet pipes adopted multiplex water supply comes true; it also supplies using of kitchen and washstand besides shower.

The present invention with the proposal mentioned above: electronic intelligent touch-control tap, both inlet pipes separately connects with cold and hot pipe of the hot water heater, user sets temperature required by control/display panel. PCB control panel receives information sent by control panel, and sends instruction to control the positive rotation or reversed rotation of synchronous electric machine after comparing this temperature with outlet water temperature by heat detector, then regulates and drives temperature-sensing valve to mix different rate of cold-hot water, thus we can regulates water temperature exactly and supplies thermostatic water. User controls flow also by control panel, PCB control panel receives information sent by control panel, and sends instruction that control electric machine to drive flow valve to regulate flow, thus user control flow.

To sum up, the invention carries out thermostatic water supply, intelligent water temperature control and flow control. It is security and convenient using.

### BRIEF DESCRIPTION OF THE DRAWINGS

FIG. 1 is an internal structure view of the embodiment 1 of the present invention.

FIG. 2 is a simplified schematic of the embodiment 1 of the present invention.

FIG. 3 is a structure view of the embodiment 2 of the present invention.

FIG. 4 is a simplified schematic of the embodiment 2 of the present invention.

FIG. 5 is a structure view of control panel of the embodiment 2 of the present invention.

### DETAILED DESCRIPTION OF THE PREFERRED EMBODIMENT

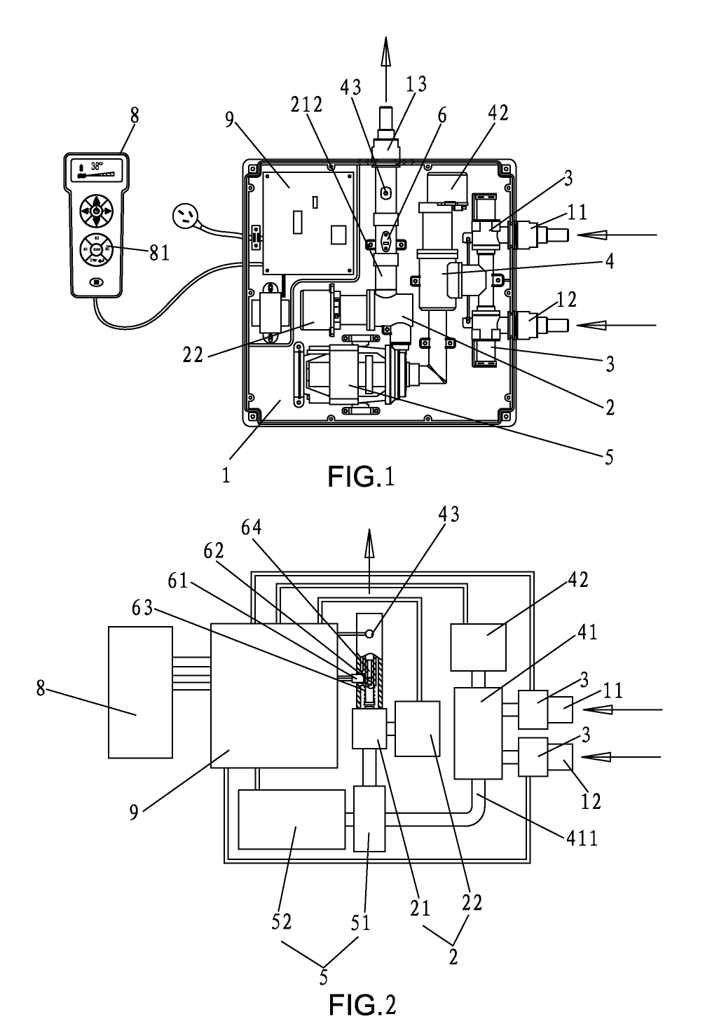

The embodiment 1, refers to FIG. 1 [symbol] FIG. 2, is a preferred embodiment of intelligent water supply CPU of the present invention.

Referring to FIG. 1, an internal structure view of the embodiment 1 of the present invention, comprising an body 1 [symbol] a top head (not shown in diagram) [symbol] magnet-valves 3 [symbol] temperature-sensing component 4 [symbol] blower pump component 5 [symbol] flow control component 2 [symbol] electronic explosion-protection component 6 [symbol] PCB control panel 9 and control panel 8.

The body 1 mentioned comprises several storage tanks using to place various kinds components, two inlet pipes 11 [symbol] 12 and one outlet pipe 13 connected by pipeline. Inlet pipe 11 [symbol] 12 connect with hot and cold pipe of the hot water heater separately.

PCB control panel 9 is in holding cavity of body 1, serves to receive and treat information responding from control panel 8 and every component, then sends control instruction.

Control panel 8 either connected with PCB control panel 9 through data wire, or transmits data to PCB control panel 9 by wireless remote. The present embodiment adopts wireless remote, several bottoms 81 served to regulate the temperature and flow are set on control panel 8. It is simple and convenient operation.

The magnet-valves 3 mentioned comprises two magnet-valve 13 [symbol] 14 installed separately in two inlet pipe 11 [symbol] 12, severs to control opening and closing of inlet pipe 11 [symbol] 12, when the shutdown or standby time, no water comes true by shutdown of magnet-valve 31 [symbol] 32.

The temperature-sensing component 4 mentioned comprises a temperature-sensing valve 41 [symbol] synchronous machine 42 and heat detector 43 [symbol] hot and cold water inflow from two inlet pipe 11 [symbol] 12 to temperature-sensing valve 41 through pipeline and mix in body of valve, heat detector 43 locates close to water pipe, surveys and evaluates the temperature of water and responds to PCB control panel 9 in time, PCB control panel 9 compares the water temperature of feedback with the temperature preinstalled by user, then sends instruction to control the positive rotation or reversed rotation of synchronous electric machine 42; synchronous machine 42 drives temperature-sensing valve 41 to regulate the mixture ratio of hot and cold water, then control outlet water temperature exactly. Additionally, you can also set the starting point of the temperature position (generally 38° C.), if preinstalled temperature is set higher than 38° C., pressing hint bottom to point out the temperature is too high; in the re-boot after shutdown, system automatically regulates initial water temperature of 38° C. to prevent the burn event in the next boot because of using too higher preinstalled temperature in last time.

A booster bumps 5 is set on pipeline behind the outlet 411 of temperature-sensing valve 41, booster bumps 5 comprises a booster bump 51 and booster bump electric machine 52. Booster bump electric machine 52 drives booster bump 51, when water pressure is lower, user chooses pressurize function by control panel 8, booster bump electric machine 52 under the control of PBC control panel starts up booster pump 51 to achieve pressurize. Additionally, pressure detection device (no shown in diagram) is also can set on pipeline between booster bump 51 and outlet 411 of temperature-sensing valve 41, serves to survey and evaluates water pressure and respond to PBC control panel 9, thus it can control pressure and achieve pressurize function automatically.

The flow control component 2 comprises a flow valve 21 [symbol] an electric machine 22, water in pipeline inflows to inlet 211 of flow valve 21 after passing booster pumps 5, as user chooses increase or decrease flow, PCB control panel sends the instruction to control the positive rotation or reversed rotation of electric machine 22, and drives flow valve 21 to regulate discharge, to achieve a water control regulation. Additional, initial flow position can be set also (in least flow position, under pressure 0.1 bar, generally water supply is 1-1.5 L/min), after boot, system control electric machine automatically to drive flow valve to an half-open position, that is default flow in boot, user can regulate flow by control panel 8 afterward. Regulation of flow is set to continuous regulation or preinstalled stall regulation (stall regulation is the same as the principle of continuous regulation, no repeat)

The electronic explosion-protection component mentioned is set between the outlet 212 of flow valve 21 and outlet pipe 13, comprising Hall IC 61 [symbol] permanent magnet 62 [symbol] spring 63 [symbol] restoring link 64, spring 63 is fixed in pipeline, restoring link 64 connects with spring 63, permanent magnet 62 is linked with restoring link 64, Hall IC 61 sketching into pipeline closes to permanent magnet 62 and connects with PCB control panel 9 through transmission line. In standby sate, when no water is out, Hall IC 61 locates nearest to permanent magnet 62 and sends high electrical frequency; after the water start, the differential pressure and kinetic energy of flow itself push away restoring pink 64, permanent magnet 62 stays away from Hall IC 61, Hall IC 61 sends low electrical frequency at this time. If waterway is blocked or inlet pipe 11 [symbol] 12 stop water, kinetic energy of flow closes to zero, the differential pressure of restoring pink 64 during before and after is zero, spring 63 pulls restoring pink 64 to reset, Hall IC 61 locates nearest to permanent magnet 62 again and sends high electrical frequency, PCB control panel 9 sends instruction to shut down or standby after receives signal, to ensure the safety of using at the time suddenly without water supply or pipeline blockage.

Like this, the invention achieves exactly temperature control function and supplies thermostatic water, realizes pressurize function by booster pumps 5, realizes flow control by flow control component 2, realizes automatic shutdown with water function by electronic explosion-protection component 6, improves safety of using. As a result of remote control, hot water heater can be installed hidden and nozzle appears outside only to save space resource. Moreover, with several outlet pipes adopted multiplex water supply comes true; it also supplies using of kitchen and washstand besides shower.

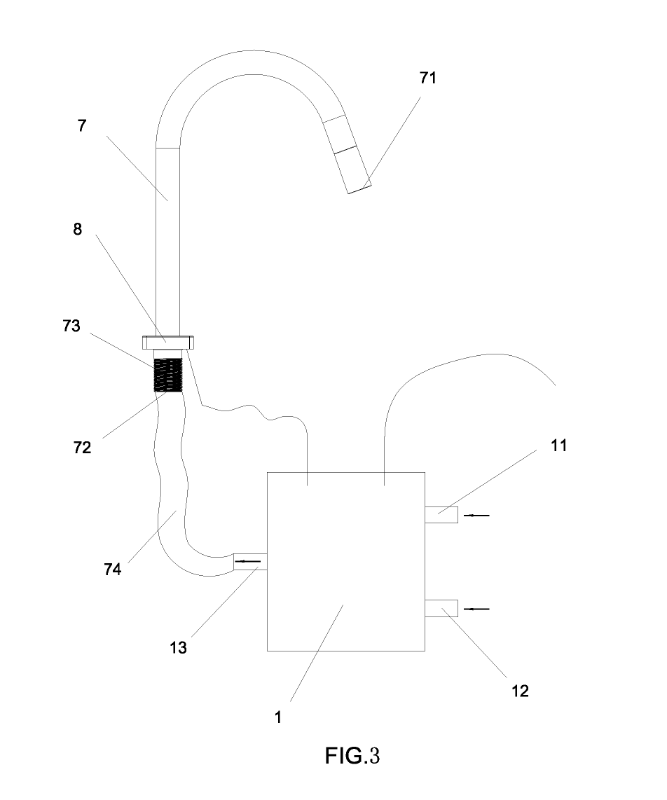

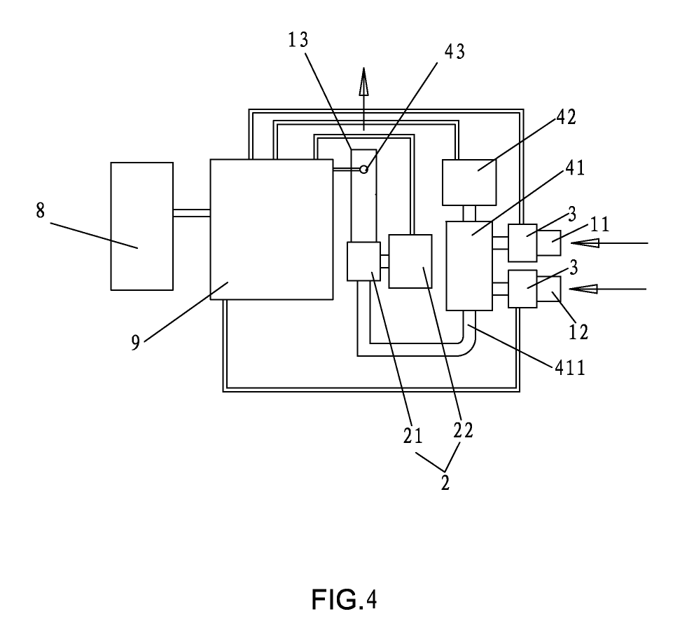

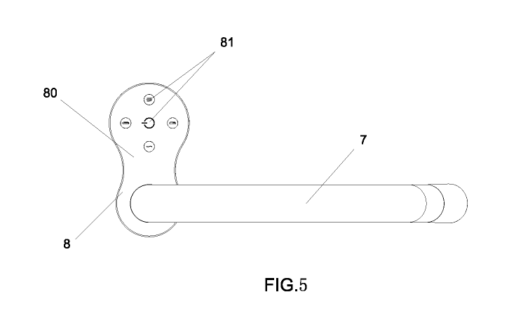

The embodiment 2, refers to FIG. 3 [symbol] FIG. 4 [symbol] FIG. 5, is a preferred embodiment of intelligent touch-control tap of the present invention.

Referring to FIG. 4, a simplified schematic of a preferred embodiment of the intelligent water supply CPU of the present invention, comprising a tap outlet pipe 7 [symbol] a control panel 8 [symbol] a valve controller; valve controller comprises: a body 1 [symbol] an electric magnet-valves 3 [symbol] a temperature-sensing component 4 [symbol] a flow control component 2 [symbol] a PCB control panel 9.

The body 1 mentioned comprises several storage tanks using to place various kinds components, two inlet pipes 11 [symbol] 12 and one outlet pipe 13 connected by pipeline. Inlet pipe 11 [symbol] 12 connect with hot and cold pipe of the hot water heater separately.

PCB control panel 9 is in holding cavity of body 1, serves to receive and treat information responding from control panel 8 and every component, then sends control instruction.

The magnet-valves 3 mentioned comprises two magnet-valve 13 [symbol] 14 installed separately in two inlet pipe 11 [symbol] 12, severs to control opening and closing of inlet pipe 11 [symbol] 12, when the shutdown or standby time, no water comes true by shutdown of magnet-valve 31 [symbol] 32.

The temperature-sensing component 4 mentioned comprises a temperature-sensing valve 41 [symbol] synchronous machine 42 and heat detector 43 [symbol] hot and cold water inflow from two inlet pipe 11 [symbol] 12 to temperature-sensing valve 41 through pipeline and mix in body of valve, heat detector 43 locates close to water pipe, surveys and evaluates the temperature of water and responds to PCB control panel 9 in time, PCB control panel 9 compares the water temperature of feedback with the temperature preinstalled by user, then sends instruction to control the positive rotation or reversed rotation of synchronous electric machine 42; synchronous machine 42 drives temperature-sensing valve 41 to regulate the mixture ratio of hot and cold water, then control outlet water temperature exactly. Additionally, you can also set the starting point of the temperature position (generally 38° C.), if preinstalled temperature is set higher than 38° C., pressing hint bottom to point out the temperature is too high; in the re-boot after shutdown, system automatically regulates initial water temperature of 38° C. to prevent the burn event in the next boot because of using too higher preinstalled temperature last time.

The flow control component 2 comprises a flow valve 21 [symbol] an electric machine 22, water in pipeline inflows to flow valve 21 through outlet 411 of temperature-sensing valve 41, as user chooses increase or decrease flow, PCB control panel sends the instruction to control the positive rotation or reversed rotation of electric machine 22, and drives flow valve 21 to regulate discharge, to achieve a water control regulation. Additional, initial flow position can be set also (in least flow position, under pressure 0.1 bar, generally water supply is 1-1.5 L/min), after boot, system control electric machine automatically to drive flow valve to an half-open position, that is default flow in boot, user can regulate flow by control panel 8 afterward. Regulation of flow is set to continuous regulation or preinstalled stall regulation.

Control panel 8 connects PCB control panel 9 through date wire, cover board of control panel 8 is made from translucent material; operational key of control panel 8 can be touch push button 81, that control temperature and display circle is made of several lampions; using lampions to reflect different temperature; certainly, display part can be made of LCD and Display Drive Circuit of LCD, like this, the temperature of outlet water shows directly in digit;

The control panel 8 is fixed on the bottom of tap outlet pipe 7, in this bottom there is external thread 72, a nut (no shown in diagram) screws to the bottom of tap outlet pipe 7, tap outlet pipe 7 is jammed between control panel 8 and nut, so that it is fixed on bedplate mentioned; e.g. on washbasin bedplate or sink bedplate; upper part of tap outlet pipe 7 bending down forms outlet 71;

Hose 74 connects outlet pipe 13 of valve control box and inlet end 73 of tap outlet pipe; Adopting hose is a favor of respective installation of valve control box and outlet pipe.

According to the need, the intelligent touch-control tap of the invention can set up booster pumps 5 and electronic explosion-protection component 6, concrete structure and installation is similar to embodiment 1 (refers to FIG. 1 [symbol] FIG. 2).

### INDUSTRIAL APPLICABILITY

The intelligent water supply CPU and tap of the invention, user sets up water temperature in demand using control panel, carry out temperature control automatically; User controls discharge also by control panel, PCB control panel receives information sent by control panel, and sends instruction that control electric machine to drive flow valve to regulate discharge, thus user control discharge. It has simple structure [symbol] convenient using and good industrial applicability.

What is claimed is:

1. An intelligent water supply CPU, comprising a body, a top head, a magnet valves, a temperature-sensing component, a flow control component, a PCB control panel and operation panel.
The body mentioned comprises several storage tanks and two water supper pipes [symbol] one outlet pipes, a temperature-sensing component, an electric explosion-protection and a PCB control panel set in body;
The electric magnetic valves mentioned comprise two electric magnetic valves set separately in two outlet pipes;
The temperature-sensing component comprises a temperature-sensing valve [symbol] a synchronous electric machine and a heat detector, two outlet water pipes connects temperature-sensing valve through ducting, synchronous electric machine regulates and drives the temperature-sensing valve, PCB control panel controls the rotation of synchronous electric machine, heat detector situated close to outlet pipe surveys and evaluates the temperature of outlet water and responses to PCB control panel;
The flow control component mentioned comprises a flow valve, electric machine, outlet of flow valve connects outlet pipe, electric machine regulates and drives flow valve, PCB control panel controls the rotation of electric machine.
The operation panel mentioned connects PCB control panel by data wire or transmits data to PCB control panel by wireless remote-control, bottoms used to adjust the temperature and flow are set on control panel.

2. The intelligent water supply CPU according to claim 1, wherein said booster pumps comprising booster pump and booster pump electric machine, is set on pipeline between the inlet of flow valve and the outlet of temperature-sensing valve, PCB control panel controls the booster pump electric machine.

3. The intelligent water supply CPU according to claim 2, wherein said a pressure detector is set on pipeline between booster pump and outlet of temperature-sensing valve, surveys and evaluates water pressure, then responds to PCB control panel.

4. The intelligent water supply CPU according to claim 1, wherein said a electric explosion-protection component comprising Hall IC [symbol] permanent magnet [symbol] spring [symbol] restoring pink, spring is fixed in pipeline; restoring pink connects spring, permanent magnet links restoring pink, Hall IC stretching into pipeline closes to permanent magnet, and is connected with PCB control panel through transmission line.

5. The intelligent water supply CPU according to claim 1, wherein said the body mentioned comprises several outlet pipes.

6. An intelligent touch-control tap, wherein said a electric intelligent touch-control water tap, comprises a outlet pipe of water tap [symbol] a control panel [symbol] a valve controller box; the valve controller box comprises: a body [symbol] a top head [symbol] electric magnet valves [symbol] a PCB control panel;
The body mentioned comprises several storage tanks and two inlet pipes [symbol] one outlet pipe, a temperature-sensing component, an electric explosion-protection and a PCB control panel set in body;
The temperature-sensing component mentioned comprises a temperature-sensing valve [symbol] a synchronous electric machine and a heat detector, two outlet pipes connects temperature-sensing valve through pipeline, synchronous electric machine regulates and drives the temperature-sensing valve, PCB control panel controls the rotation of synchronous electric machine, heat detector situated close to outlet pipe surveys and evaluates the temperature of outlet water and responses to PCB control panel;
The flow control component mentioned comprises a flow valve [symbol] electric machine, outlet of flow valve connects outlet pipe, electric machine regulates and drives flow valve, PCB control panel controls the rotation of electric machine.
The control panel connects PCB control panel through data wire translucent material, the cover board of control panel is made from translucent material, operational key of control panel can be touch push button.

7. The intelligent touch-control tap according to claim 6, wherein said boost pumps comprising boost pump and boost pump electric machine, is set on pipeline between the inlet of flow valve and the outlet of temperature-sensing valve, PCB control panel controls the boost pump electric machine.

8. The intelligent touch-control tap according to claim 6, wherein said a pressure detector is set on pipeline between boost pump and outlet of temperature-sensing valve, surveys and evaluates water pressure, then responds to PCB control panel.

9. The intelligent touch-control tap according to claim 6, wherein said a electric explosion-protection component is set between outlet pipe and inlet pipe of flow valve, comprising Hall IC [symbol] permanent magnet [symbol] spring [symbol] restoring pink, spring is fixed in pipeline; restoring pink connects spring, permanent magnet links restoring pink, Hall IC stretching into pipeline close to permanent magnet, and is connected with PBC control panel through transmission line.

10. The intelligent touch-control tap according to claim 6, wherein said control temperature and display circle of control panel is made of several lampions; using lampions to reflect different temperature; certainly, display part can be made of LCD and Display Drive Circuit of LCD, like this, the temperature of outlet water shows directly in digit.
